(19) United States
(12) Patent Application Publication
(10) Pub. No.: US 2025/0046986 A1
(43) Pub. Date: Feb. 6, 2025

(54) ELECTRONIC DEVICE AND ELECTRONIC DEVICE ASSEMBLY

(71) Applicant: HUAWEI TECHNOLOGIES CO., LTD., Shenzhen (CN)

(72) Inventors: Bin Zou, Xi’an (CN); Zhi Guo, Xi’an (CN); Bing Liu, Xi’an (CN); Ziyi Wang, Xi’an (CN)

(21) Appl. No.: 18/920,712

(22) Filed: Oct. 18, 2024

Related U.S. Application Data
(63) Continuation of application No. PCT/CN2023/087503, filed on Apr. 11, 2023.

(30) Foreign Application Priority Data
Apr. 19, 2022 (CN) 202220901039.0

(51) Int. Cl. H01Q 1/27; G04G 17/04; H01Q 1/50

(52) U.S. Cl. CPC H01Q 1/273; G04G 17/04; H01Q 1/50

(57) ABSTRACT

Embodiments of this application provide an electronic device and an electronic device assembly. The electronic device includes at least a casing and an antenna assembly. At least one outer side wall of the casing is provided with a first groove that is configured to connect at least the electronic device and an external component, a first receiving cavity is further provided inside the casing, at least a part of a radiating element of the antenna assembly is located in the first receiving cavity, and a projection of the first receiving cavity in a thickness direction of the electronic device at least partially overlaps with a projection of the first groove in the thickness direction of the electronic device. In this way, a size of the electronic device can be reduced, so that the entire electronic device is small. This can improve wearing experience of a user.

### CROSS-REFERENCE TO RELATED APPLICATIONS

This application is a continuation of International Application No. PCT/CN2023/087503, filed on Apr. 11, 2023, which claims priority to Chinese Patent Application No. 202220901039.0, filed on Apr. 19, 2022. The disclosures of the aforementioned applications are hereby incorporated by reference in their entireties.

### TECHNICAL FIELD

Embodiments of this application relate to the field of wearable device technologies, and in particular, to an electronic device and an electronic device assembly.

### BACKGROUND

An electronic device usually exists in a form of portable accessory that has some computing functions and can be connected to a mobile phone and various terminals. Mainstream product forms include a watch type (for example, a watch, a band, or a wrist strap) supported by a wrist, a shoes type (for example, shoes, socks, or another product worn on legs in the future) supported by feet, and a glass type (for example, glasses, a helmet, or a headband) supported by head. Non-mainstream product forms include smart clothing, a schoolbag, a cane, an accessory, and the like.

For a product like the watch or the band supported by the wrist, to ensure that the product has good antenna performance, an antenna design usually requires an antenna clearance of at least 1 mm (which is usually a distance between an antenna and another metal component inside an entire device, for example, a distance between the antenna and a battery). With continuous evolution of competitiveness such as product miniaturization, the antenna clearance is further reduced. In a related technology, to ensure a sufficient antenna clearance, a size of a watch or a band in a wearing span direction is usually designed to be large.

However, in the foregoing solution, because the size of the watch or the band in the wearing span direction is large, an overall length of the watch or the band is large. This affects wearing experience of a user.

### SUMMARY

Embodiments of this application provide an electronic device and an electronic device assembly, so that a size of the electronic device can be reduced, and the entire electronic device is small. This can improve wearing experience of a user.

According to a first aspect, an embodiment of this application provides an electronic device. The electronic device includes at least a casing and an antenna assembly. At least one outer side wall of the casing is provided with a first groove that is configured to connect at least the electronic device and an external component. A first receiving cavity is further provided inside the casing. At least a part of a radiating element of the antenna assembly is located in the first receiving cavity, and a projection of the first receiving cavity in a thickness direction of the electronic device at least partially overlaps with a projection of the first groove in the thickness direction of the electronic device.

According to the electronic device provided in this embodiment of this application, in the electronic device, the at least one outer side wall of the casing is provided with the first groove that is configured to connect at least the electronic device and the external component. The first receiving cavity is further provided inside the casing. The projection of the first receiving cavity in the thickness direction of the electronic device at least partially overlaps with the projection of the first groove in the thickness direction of the electronic device. The first receiving cavity is configured to accommodate the at least the part of the radiating element of the antenna assembly. In this way, when a watch strap head grain is placed in the first groove, a projection of the watch strap head grain in the thickness direction of the electronic device overlaps with a projection of the at least the part of the radiating element of the antenna assembly in the thickness direction of the electronic device. In other words, locations of the watch strap head grain and the radiating element of the antenna assembly do not interfere with each other in a length direction or a width direction of the electronic device, and occupy a small space, so that a size of the electronic device can be reduced, and the entire electronic device is small. This can improve wearing experience of a user to some extent.

In a possible implementation, the first receiving cavity is located in a space enclosed by a middle frame of the electronic device, a top wall of the first groove, an outer side wall that is of the casing and that is away from the middle frame, and a plane on which a display of the electronic device is located.

In a possible implementation, the antenna assembly includes at least the radiating element and a feeding unit connected to the radiating element. The feeding unit is further connected to a circuit board of the electronic device.

In this way, a part of the radiating element of the antenna assembly is located in the first receiving cavity, the feeding unit and the remaining part of the radiating element of the antenna assembly are located in an accommodating cavity formed between an outer side wall of a battery and an inner side wall of the casing, and the feeding unit is connected to a circuit board of the electronic device, so that a feeding function and radiation performance of the antenna assembly can be ensured.

In a possible implementation, the antenna assembly further includes a radiating branch. One end of the radiating element is connected to one end of the radiating branch, the other end of the radiating element is connected to the feeding unit, and the other end of the radiating branch bends in a direction away from a surface of the radiating element, and extends toward an extension direction of the radiating element. The radiating branch is designed and added, and the radiating branch is connected to an end that is of the radiating element and that is away from the feeding unit, so that the radiating branch can perform a tuning function. For example, antenna resonance frequency tuning can be performed through a length change of the radiating branch. This improves radiation performance of the radiating element and increases an implementable function of the antenna assembly.

In a possible implementation, the radiating element includes a main body portion and a bending support portion. One end of the main body portion is connected to the radiating branch, the other end of the main body portion is connected to one end of the bending support portion, and the other end of the bending support portion is connected to the feeding unit.

In a possible implementation, the radiating element has a first side face and a second side face opposite to the first side face. One end of the radiating branch is connected to one end of the main body portion of the radiating element, and the other end of the radiating branch bends in a direction away from the second side face and extends toward the other end of the main body portion. One end of the feeding unit is connected to one end of the bending support portion of the radiating element, and the other end of the feeding unit extends in a direction perpendicular to a plane on which the bending support portion is located.

In a possible implementation, the radiating element has a first side face and a second side face opposite to the first side face. One end of the radiating branch is connected to one end of the main body portion of the radiating element, and the other end of the radiating branch bends in a direction away from the first side face and extends toward the other end of the main body portion. One end of the feeding unit is connected to one end of the bending support portion of the radiating element, and the other end of the feeding unit extends in a direction perpendicular to a plane on which the bending support portion is located.

In a possible implementation, the antenna assembly further includes a grounding unit. One end of the radiating element is connected to the grounding unit, and the other end of the radiating element is connected to the feeding unit. The grounding unit and the feeding unit are disposed opposite to each other. The grounding unit is disposed in the antenna assembly, and the grounding unit is connected to an end that is of the radiating element and that is away from the feeding unit. The grounding unit, the radiating element, and the feeding unit form a loop antenna, so that a tuning function can be implemented, radiation performance of the radiating element can be improved, and an implementable function of the antenna assembly can be increased.

In a possible implementation, the radiating element is provided with a coupling gap. The coupling gap is disposed in a staggered manner relative to the grounding unit and the feeding unit. The radiating element is provided with the coupling gap, and the grounding unit, the feeding unit, and the radiating element having the coupling gap form a coupling loop antenna, so that a tuning function can be further performed, radiation performance of the radiating element can be further improved, and an implementable function of the antenna assembly can be further increased.

In a possible implementation, the radiating element includes a main body portion and a bending support portion. One end of the main body portion is connected to the grounding unit, the other end of the main body portion is connected to one end of the bending support portion, and the other end of the bending support portion is connected to the feeding unit. Alternatively, one end of the main body portion is connected to the feeding unit, the other end of the main body portion is connected to one end of the bending support portion, and the other end of the bending support portion is connected to the grounding unit.

In a possible implementation, the electronic device further includes a battery. The battery is located inside the casing. An accommodating cavity is formed between an outer side wall of the battery and an inner side wall of the casing. The accommodating cavity is configured to accommodate at least the feeding unit. The accommodating cavity communicates with the first receiving cavity to jointly accommodate the antenna assembly. The first receiving cavity communicates with the accommodating cavity formed between the outer side wall of the battery and the inner side wall of the casing. In this way, the radiating element of the antenna assembly is located in the first receiving cavity, and other parts of the antenna assembly than the radiating element are located in the accommodating cavity formed between the outer side wall of the battery and the inner side wall of the casing. This ensures that the antenna assembly is placed inside the casing.

In a possible implementation, a distance between the battery and the radiating element is greater than 1 mm. A sufficient distance between the battery and the radiating element can ensure a clearance of the antenna.

According to a second aspect, an embodiment of this application provides an electronic device assembly. The electronic device assembly includes at least a watch strap assembly and any one of the foregoing electronic devices. The watch strap assembly is connected to the electronic device by using the first groove.

According to the electronic device assembly provided in this embodiment of this application, the electronic device assembly includes at least an electronic device. In the electronic device, at least one outer side wall of a casing is provided with a first groove that is configured to connect at least the electronic device and an external component. A first receiving cavity is further provided inside the casing. A projection of the first receiving cavity in a thickness direction of the electronic device at least partially overlaps with a projection of the first groove in the thickness direction of the electronic device. The first receiving cavity is configured to accommodate at least a part of a radiating element of an antenna assembly. In this way, when a watch strap head grain is placed in the first groove, a projection of the watch strap head grain in the thickness direction of the electronic device overlaps with a projection of the at least the part of the radiating element of the antenna assembly in the thickness direction of the electronic device. In other words, locations of the watch strap head grain and the radiating element of the antenna assembly do not interfere with each other in a length direction or a width direction of the electronic device, and occupy a small space, so that a size of the electronic device can be reduced, and the entire electronic device is small. This can improve wearing experience of a user to some extent.

In a possible implementation, the electronic device assembly further includes a watch strap assembly. The watch strap assembly includes a watch strap and a spring bar connected to the watch strap. The first groove is located at one end that is of the casing and that faces the watch strap, and the spring bar is located in the first groove to connect the casing and the watch strap assembly.

In a possible implementation, a spring bar hole is provided on a side wall of the first groove of the electronic device. Two ends of the spring bar are located in the spring bar hole.

In a possible implementation, the watch strap assembly further includes a watch strap head grain. The watch strap head grain is connected to the watch strap. At least a part of the watch strap head grain is located in the first groove. A through hole extending in a width direction of the casing is provided in the watch strap head grain, and the spring bar runs through the through hole to connect the casing and the watch strap assembly. The spring bar hole and the through hole are disposed opposite to each other.

### BRIEF DESCRIPTION OF DRAWINGS

FIG. 1 is a diagram of a cross section of an electronic device assembly in the conventional technology;

FIG. 2A is a diagram of a cross section of an electronic device assembly according to an embodiment of this application;

FIG. 2B is a partial enlarged diagram of FIG. 2A;

FIG. 3 is a diagram of a cross section of an electronic device according to an embodiment of this application;

FIG. 4 is a diagram of a structure of an electronic device according to an embodiment of this application;

FIG. 5 is a diagram of a structure of an antenna assembly in an electronic device according to an embodiment of this application;

FIG. 6 is a diagram of a structure in which an antenna assembly and a casing in an electronic device match according to an embodiment of this application;

FIG. 7 is a diagram of a structure in which a watch strap head grain and a spring bar in an electronic device match according to an embodiment of this application;

FIG. 8 is a diagram of a structure of an antenna assembly in an electronic device according to an embodiment of this application;

FIG. 9 is a diagram of a structure in which an antenna assembly and a casing in an electronic device match according to an embodiment of this application;

FIG. 10 is a diagram of a structure of an antenna assembly in an electronic device according to an embodiment of this application;

FIG. 11 is a diagram of a structure in which an antenna assembly and a casing in an electronic device match according to an embodiment of this application;

FIG. 12 is a diagram of a structure of an antenna assembly in an electronic device according to an embodiment of this application;

FIG. 13 is a diagram of a structure of an antenna assembly in an electronic device according to an embodiment of this application;

FIG. 14 is a diagram of a structure in which an antenna assembly and a casing in an electronic device match according to an embodiment of this application;

FIG. 15 is a diagram of a structure of an antenna assembly in an electronic device according to an embodiment of this application;

FIG. 16 is a diagram of a structure of an antenna assembly in an electronic device according to an embodiment of this application; and

FIG. 17 is a diagram of a structure in which an antenna assembly and a casing in an electronic device match according to an embodiment of this application.

### DESCRIPTIONS OF REFERENCE NUMERALS

100-wearable electronic device; 110-casing; 1101-first outer side wall of the casing; 111-first groove; 1111-top wall of the first groove; 112-first receiving cavity; 120-watch strap assembly; 121-watch strap; 1211-second groove; 122-watch strap head grain; 1221-first part; 1222-second part; 1223-through hole; 123-spring bar; 130-second receiving cavity; 131-spring bar hole; 140-antenna assembly; 141-radiating element; 1411-main body portion; 1411a-first side face; 1411b-second side face; 1412-bending support portion; 1413-coupling gap; 142-feeding unit; 143-radiating branch; 144-grounding unit; 150-battery; 160-accommodating cavity; 170-circuit board; 180-spring; 190-display; 200-middle frame; L1-wearing span direction; D1-first clearance distance; D2-second clearance distance; 210-antenna support; 220-FPC antenna; 230-watch strap connection mechanism.

### DESCRIPTION OF EMBODIMENTS

Terms used in implementations of this application are merely used to explain specific embodiments of this application, but are not intended to limit this application. The following describes implementations of embodiments of this application in detail with reference to the accompanying drawings.

An embodiment of this application provides an electronic device. The electronic device may be a wearable electronic device, for example, an electronic device that can be worn on a human body or a life body, for example, a watch, a band, or a finger ring. In this embodiment of this application, a watch is used as a specific example for illustration. It may be understood that the watch does not limit a specific type of the electronic device.

It should be noted that the watch shown in this embodiment of this application is shown by using a rectangular watch face as an example. It should be understood that a shape of the watch face of the watch may alternatively be a circle, an ellipse, a square, or another polygon. The rectangular watch face in this embodiment of this application is merely used as a specific example, and does not specifically limit the shape of the watch face.

It may be understood that the wearable electronic device usually includes an electronic device body and a wearing component, and the electronic device body is connected to the wearing component, to facilitate wearing of the electronic device by a human body. The wearing component may be a wristband, a watch strap, or the like. In some possible examples, the wearing component may alternatively be an annular buckle of a finger ring, an annular band of a neck strap, or the like.

Currently, an electronic device body of a wearable electronic device usually integrates various functions such as making a call and playing music. To implement a communication function of the wearable electronic device, an antenna may be disposed on the electronic device body, to transmit and receive a signal through the antenna. An antenna performance level of the wearable electronic device in an actual use scenario directly relates to actual user experience.

To ensure that the wearable electronic device has good antenna performance, an antenna design usually requires an antenna clearance of at least 1 mm. The antenna clearance is a distance between an antenna and a battery. In a related technology, a size of a watch or a band in a wearing span direction is usually designed to be large, to ensure a sufficient antenna clearance. In addition, if a body width of the wearable electronic device (for example, a band or a watch) is large, wearing comfort of a wrist of a human body is affected. Therefore, the body width of the wearable electronic device is usually designed to be narrow, which leads to a great length of the entire device, to ensure that the body has a specific volume to accommodate various electronic components.

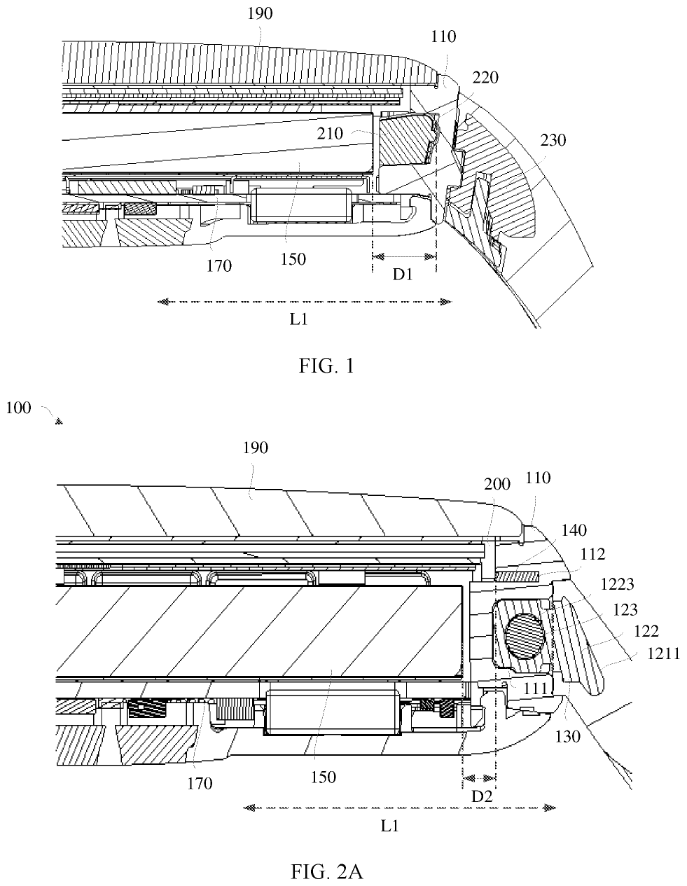

Specifically, as shown in FIG. 1, an antenna structure is disposed inside a casing 110 of the electronic device body, and the antenna structure includes an antenna support 210 and a flexible printed circuit (Flexible Printed Circuit, FPC) antenna. The antenna support 210 is configured to fasten and support an FPC antenna 220. A watch strap connection mechanism 230 is disposed at an end that is of the wearing component and that is close to the casing 110. The watch strap connection mechanism 230 is configured to connect the casing 110 and the wearing component, to implement integral assembly of the wearable electronic device.

However, in the foregoing solution, the antenna support 210, the FPC antenna 220, and the watch strap connection mechanism 230 are arranged in a wearing span direction L1. To ensure that a distance (namely, a first clearance distance D1) between the FPC antenna 220 and the battery 150 is large enough, a size of the wearable electronic device in the wearing span direction L1 is large. Consequently, a length of the entire wearable electronic device is large. This affects wearing experience of a user.

In view of this, an embodiment of this application provides a new electronic device. In the electronic device, at least one outer side wall of a casing is provided with a first groove that is configured to connect at least the electronic device and an external component. A first receiving cavity is further provided inside the casing. A projection of the first receiving cavity in a thickness direction of the electronic device at least partially overlaps with a projection of the first groove in the thickness direction of the electronic device. The first receiving cavity is configured to accommodate at least a part of a radiating element of an antenna assembly. In this way, when a watch strap head grain is placed in the first groove, a projection of the watch strap head grain in the thickness direction of the electronic device overlaps with a projection of the at least the part of the radiating element of the antenna assembly in the thickness direction of the electronic device. In other words, locations of the watch strap head grain and the radiating element of the antenna assembly do not interfere with each other in a length direction or a width direction of the electronic device, and occupy a small space, so that a size of the electronic device can be reduced, and the entire electronic device is small. This can improve wearing experience of a user to some extent.

The following describes in detail a specific structure of the electronic device provided in this embodiment of this application with reference to the accompanying drawings.

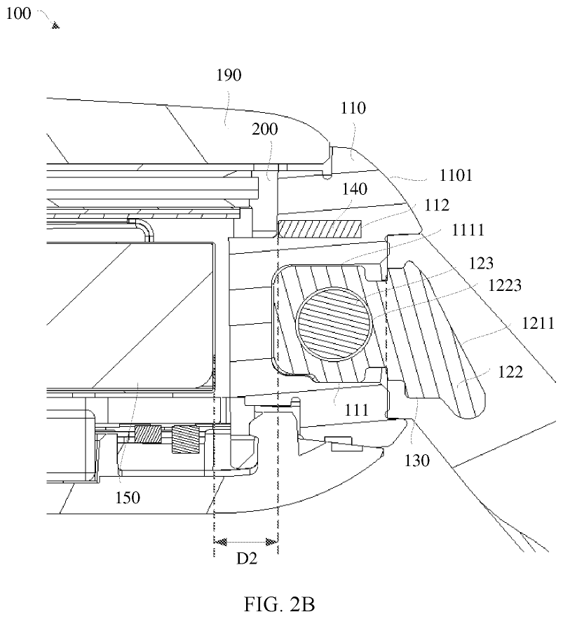

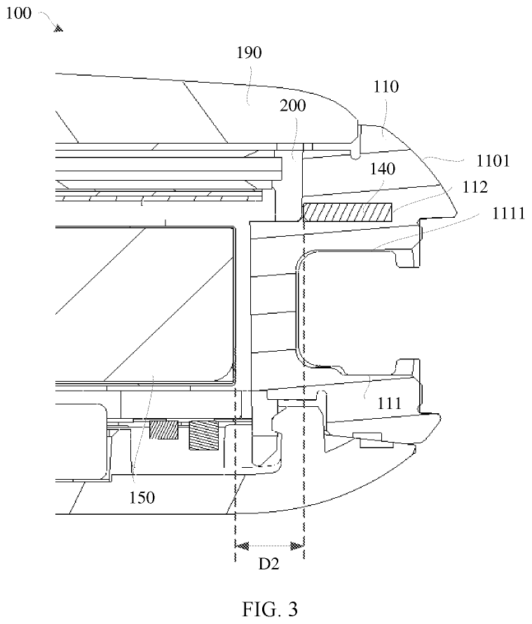

Refer to FIG. 2A, FIG. 2B, and FIG. 3. An embodiment of this application provides an electronic device. The electronic device may include at least a casing 110 and an antenna assembly 140. At least one outer side wall of the casing 110 is provided with a first groove 111 that is configured to connect at least the electronic device and an external component (for example, a watch strap 121). A first receiving cavity 112 is further provided inside the casing 110. At least a part of a radiating element 141 of the antenna assembly 140 is located in the first receiving cavity 112, and a projection of the first receiving cavity 112 in a thickness direction of the electronic device at least partially overlaps with a projection of the first groove 111 in the thickness direction of the electronic device.

Still refer to FIG. 2A, FIG. 2B, and FIG. 3. The electronic device may further include a display 190, and the display 190 may cover an upper surface of the casing 110.

In this embodiment of this application, the first receiving cavity 112 may be located above the first groove 111. Specifically, as shown in FIG. 2B or FIG. 3, the first receiving cavity 112 may be located in a space enclosed by a middle frame 200, a top wall 1111 of the first groove, an outer side wall (namely, a first outer side wall 1101 of the casing) that is of the casing 110 and that is away from the middle frame 200, and a plane on which the display 190 is located.

In a possible implementation, the casing 110 may be formed by injection molding.

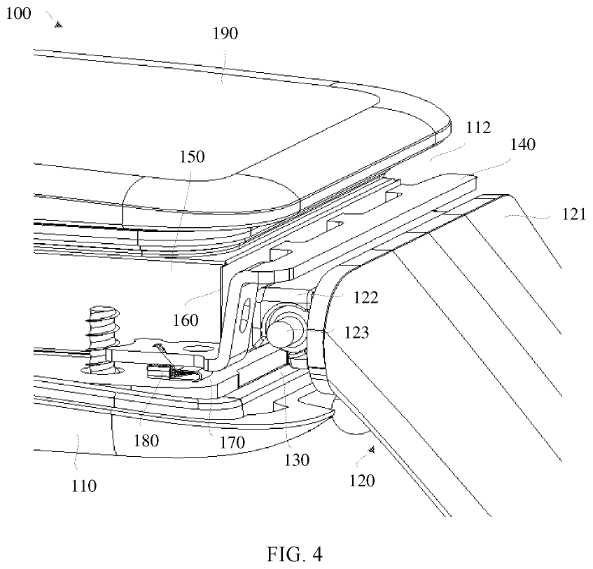

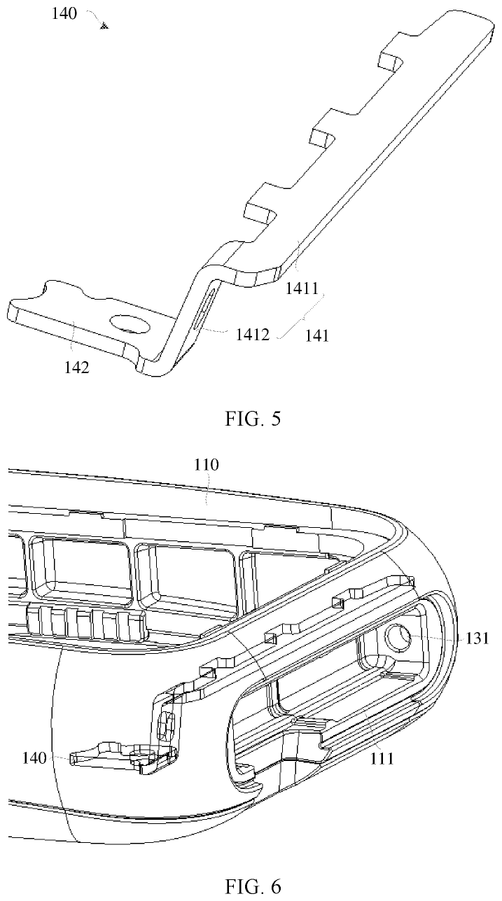

As shown in FIG. 5 and FIG. 6, in this embodiment of this application, the antenna assembly 140 may include at least a feeding unit 142 and the radiating element 141. The feeding unit 142 may be connected to a circuit board 170 of the electronic device (refer to FIG. 4).

It may be understood that, in this embodiment of this application, the radiating element 141 and the feeding unit are not located on a same plane. Specifically, a part of the radiating element 141 of the antenna assembly 140 is located in the first receiving cavity 112, the feeding unit 142 and the remaining part of the radiating element 141 of the antenna assembly 140 are located in an accommodating cavity 160 formed between an outer side wall of a battery 150 and an inner side wall of the casing 110, and the feeding unit 142 is connected to the circuit board 170 of the electronic device. This can ensure a feeding function and radiation performance of the antenna assembly 140.

It should be noted that, in this embodiment of this application, the feeding unit 142 may be connected to the circuit board 170 of the electronic device by using a spring 180 (refer to FIG. 4).

An example in which the electronic device is a body of a watch is used as an example. A location of the feeding unit 142 disposed on the watch may be, for example, in a two o'clock direction, a ten o'clock direction, a four o'clock direction, or an eight o'clock direction. This is not limited in embodiments of this application.

It should be noted that, in this embodiment of this application, the antenna assembly 140 may be used in a Bluetooth antenna or a global positioning system (Global Positioning System, GPS) antenna. The antenna assembly 140 may be, for example, a monopole antenna, an inverted antenna, or a loop antenna. For example, the antenna assembly 140 shown in FIG. 5 is a monopole antenna.

Certainly, on a basis that the antenna assembly 140 is a monopole antenna, refer to FIG. 8 to FIG. 11. The antenna assembly 140 may further include a radiating branch 143. One end of the radiating element 141 is connected to one end of the radiating branch 143, and the other end of the radiating element 141 is connected to the feeding unit 142; and the other end of the radiating branch 143 bends in a direction away from a surface of the radiating element 141, and extends toward an extension direction of the radiating element 141.

The radiating branch 143 is designed and added, and the radiating branch 143 is connected to an end that is of the radiating element 141 and that is away from the feeding unit 142, so that the radiating branch 143 can perform a tuning function. For example, antenna resonance frequency tuning can be performed through a length change of the radiating branch 143. This improves radiation performance of the radiating element 141 and increases an implementable function of the antenna assembly 140.

It should be noted that, as shown in FIG. 8 or FIG. 10, the radiating element 141 includes a main body portion 1411 and a bending support portion 1412. One end of the main body portion 1411 is connected to the radiating branch 143, the other end of the main body portion 1411 is connected to one end of the bending support portion 1412, and the other end of the bending support portion 1412 is connected to the feeding unit 142.

In addition, in this embodiment of this application, with reference to FIG. 8 and FIG. 10, a plane on which the feeding unit 142 is located may be parallel with a plane on which the main body portion 1411 of the radiating element 141 is located. However, the feeding unit 142 and the main body portion 1411 are located at different heights in the casing 110.

Refer to FIG. 8 and FIG. 10. The radiating element 141 has a first side face 1411a and a second side face 1411b. The second side face 1411b is opposite to the first side face 1411a, and the radiating branch 143 is used as a bending radiation part.

It may be understood that the antenna assembly 140 having the radiating branch 143 includes but is not limited to the following two possible implementations.

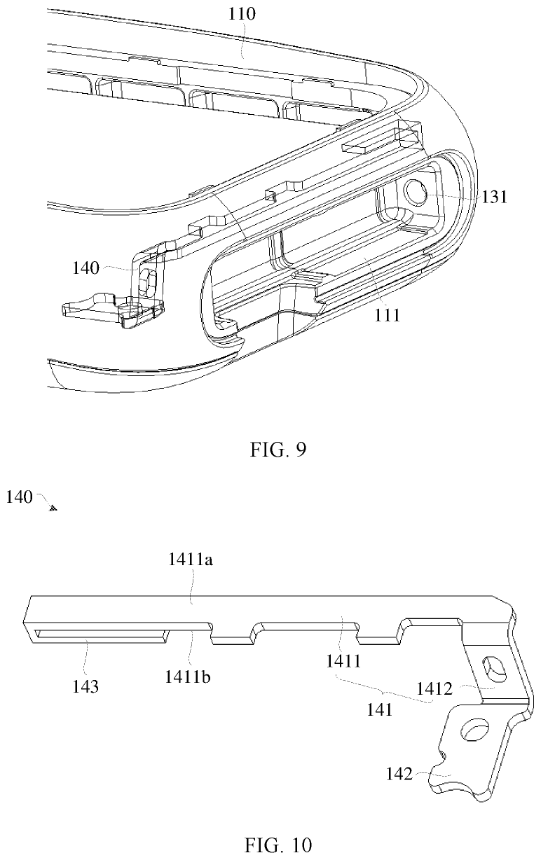

In a possible implementation, with reference to FIG. 8 and FIG. 9, the radiating branch 143 and the feeding unit 142 are located on different sides of the radiating element 141. Specifically, one end of the radiating branch 143 is connected to one end of the main body portion 1411 of the radiating element 141, and the other end of the radiating branch 143 bends in a direction away from the second side face 1411b and extends toward the other end of the main body portion 1411. In this case, the radiating branch 143 is disposed close to the first side face 1411a of the radiating element 141. One end of the feeding unit 142 is connected to one end of the bending support portion 1412 of the radiating element 141, and the other end of the feeding unit 142 extends in a direction perpendicular to a plane on which the bending support portion 1412 is located.

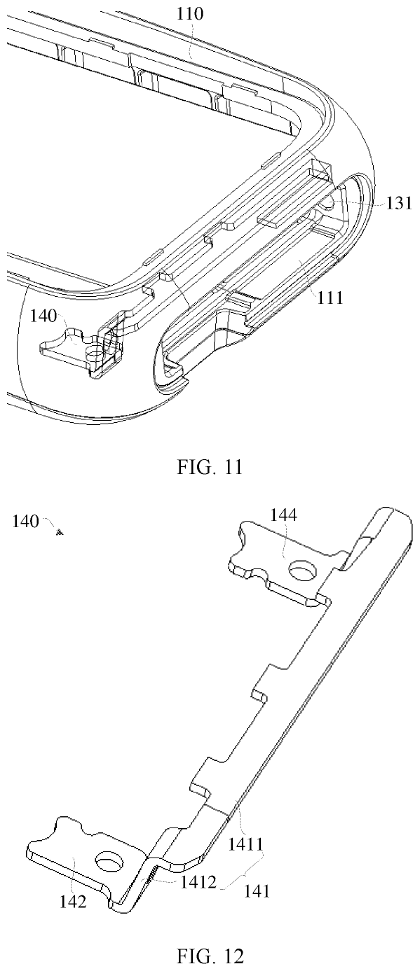

In another possible implementation, with reference to FIG. 10 and FIG. 11, the radiating branch 143 and the feeding unit 142 are located on one side of the radiating element 141. Specifically, one end of the radiating branch 143 is connected to one end of the main body portion 1411 of the radiating element 141, and the other end of the radiating branch 143 bends in a direction away from the first side face 1411a and extends toward the other end of the main body portion 1411. In this case, the radiating branch 143 is disposed close to the second side face 1411b of the radiating element 141. One end of the feeding unit 142 is connected to one end of the bending support portion 1412 of the radiating element 141, and the other end of the feeding unit 142 extends in a direction perpendicular to a plane on which the bending support portion 1412 is located.

For example, with reference to FIG. 10, both the radiating branch 143 and the feeding unit 142 are located on the second side face 1411b of the radiating element 141. Alternatively, in some other embodiments, both the radiating branch 143 and the feeding unit 142 may be located on the first side face 1411a of the radiating element 141.

It may be understood that a specific location at which the radiating branch 143 is disposed is not limited in embodiments of this application. For example, the radiating branch 143 may be further added to any location in the middle of the radiating element 141 in the antenna assembly 140.

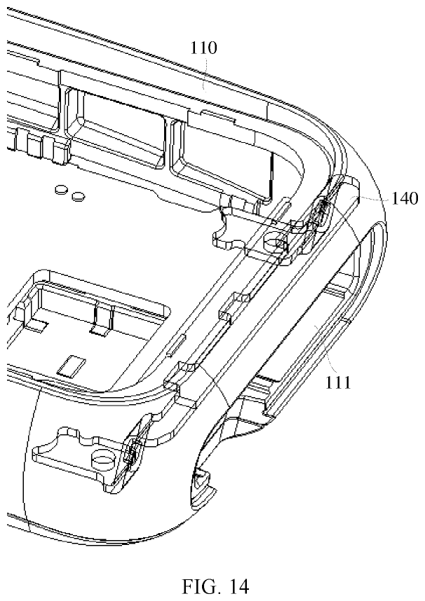

In some other embodiments, for example, when the antenna assembly 140 is a loop antenna, as shown in FIG. 12 to FIG. 14, the antenna assembly 140 may further include a grounding unit 144. One end of the radiating element 141 is connected to the grounding unit 144, and the other end of the radiating element 141 is connected to the feeding unit 142. The grounding unit 144 and the feeding unit 142 are disposed opposite to each other.

The grounding unit 144 is disposed in the antenna assembly 140, and the grounding unit 144 is connected to an end that is of the radiating element 141 and that is away from the feeding unit 142. The grounding unit 144, the radiating element 141, and the feeding unit 142 form a loop antenna, so that a tuning function can be implemented, radiation performance of the radiating element 141 can be improved, and an implementable function of the antenna assembly 140 can be increased.

Specifically, in some embodiments, with reference to FIG. 12, the radiating element 141 may include a main body portion 1411 and a bending support portion 1412. One end of the main body portion 1411 is connected to the grounding unit 144, the other end of the main body portion 1411 is connected to one end of the bending support portion 1412, and the other end of the bending support portion 1412 is connected to the feeding unit 142.

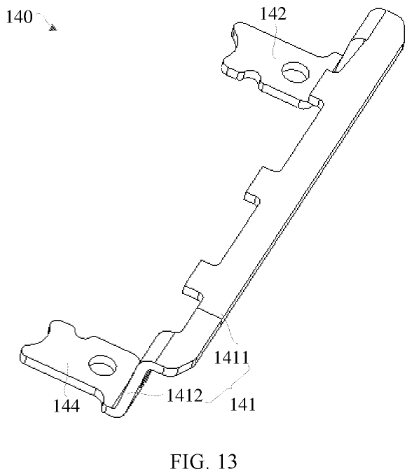

Alternatively, in some other embodiments, as shown in FIG. 13, one end of the main body portion 1411 may be connected to the feeding unit 142, the other end of the main body portion 1411 may be connected to one end of the bending support portion 1412, and the other end of the bending support portion 1412 may be connected to the grounding unit 144.

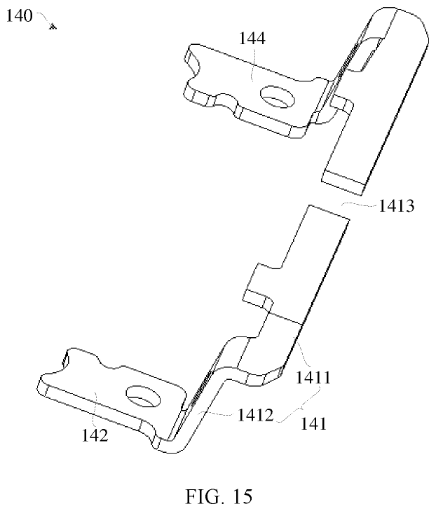

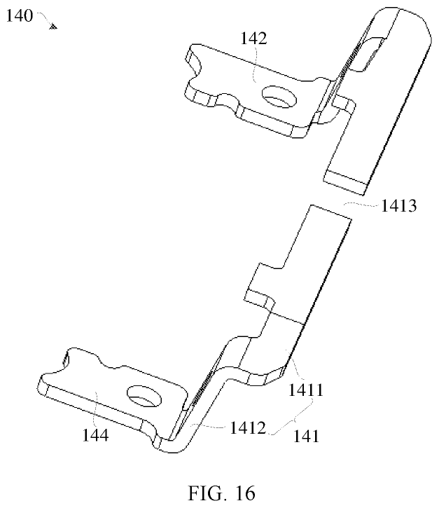

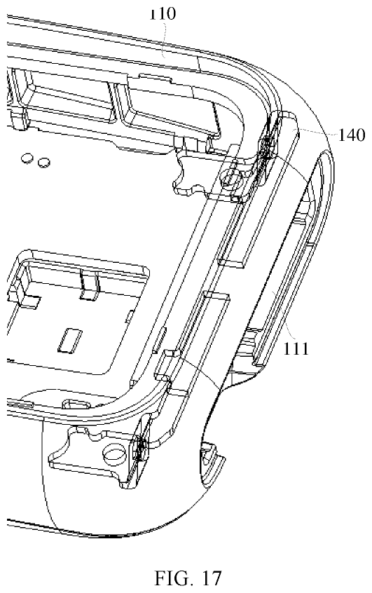

In addition, based on FIG. 12 to FIG. 14, with reference to FIG. 15 to FIG. 17, the radiating element 141 may be provided with a coupling gap 1413. The coupling gap 1413 is disposed in a staggered manner relative to the grounding unit 144 and the feeding unit 142. The radiating element 141 is provided with the coupling gap 1413, and the grounding unit 144, the feeding unit 142, and the radiating element 141 having the coupling gap 1413 form a coupling loop antenna, so that a tuning function can be further performed, radiation performance of the radiating element 141 can be further improved, and an implementable function of the antenna assembly 140 can be further increased.

An example in which the electronic device is a body of a watch is used. A location of the feeding unit 142 disposed on the watch may be, for example, in a one o'clock direction, an eleven o'clock direction, a five o'clock direction, or a seven o'clock direction. This is not limited in embodiments of this application.

It should be noted that the antenna assembly 140 in the electronic device provided in this embodiment of this application is an insert antenna. To be specific, the antenna assembly 140 is embedded in the first receiving cavity 112 and the accommodating cavity 160 formed between the outer side wall of the battery 150 and the inner side wall of the casing 110.

In some embodiments, the antenna assembly 140 may be formed by using a conductive metal. For example, the antenna assembly 140 may be formed by using a steel sheet, a copper material, or another conductive material. The antenna assembly 140 is inserted into the casing 110 through insert injection molding or other techniques.

Still with reference to FIG. 2B or FIG. 4, the electronic device may further include a battery 150. The battery 150 is located inside the casing 110. An accommodating cavity 160 is formed between an outer side wall of the battery 150 and an inner side wall of the casing 110. The accommodating cavity 160 is configured to accommodate at least the feeding unit 142. In addition, the accommodating cavity 160 communicates with the first receiving cavity 112 to jointly accommodate the antenna assembly 140.

The first receiving cavity 112 communicates with the accommodating cavity 160 formed between the outer side wall of the battery 150 and the inner side wall of the casing 110. In this way, the radiating element 141 of the antenna assembly 140 is located in the first receiving cavity 112, and other parts of the antenna assembly 140 than the radiating element 141 are located in the accommodating cavity 160 formed between the outer side wall of the battery 150 and the inner side wall of the casing 110. This ensures that the antenna assembly 140 is placed inside the casing 110.

In this embodiment of this application, a distance (namely, a second clearance distance D2) between the battery 150 and the radiating element 141 may be greater than 1 mm. A sufficient distance between the battery 150 and the radiating element 141 can ensure a clearance of the antenna.

For example, the distance between the battery 150 and the radiating element 141 may be 1 mm, 1.5 mm, 2 mm, 2.5 mm, 3 mm, 3.5 mm, 4 mm, or the like. This is not limited in embodiments of this application, and is not limited to the foregoing example.

It should be noted herein that values and value ranges in this application are approximate values, and an error within a specific range may exist due to impact of a manufacturing process. Persons skilled in the art may consider that the error is negligible.

In addition, an embodiment of this application further provides an electronic device assembly. The electronic device assembly may include at least a watch strap assembly 120 and the foregoing electronic device. The watch strap assembly 120 is connected to the electronic device.

With reference to FIG. 4, in this embodiment of this application, the watch strap assembly 120 may include a watch strap 121 and a watch strap head grain 122. The watch strap 121 is connected to the watch strap head grain 122. Specifically, with reference to FIG. 2B, a second groove 1211 is provided at an end that is of the watch strap 121 and that faces the casing 110, and the watch strap head grain 122 is located in the second groove 1211 of the watch strap 121 and is connected to the watch strap 121.

The first groove 111 is located at an end that is on the casing 110 and that faces the watch strap 121. At least a part of the watch strap head grain 122 is located in the first groove 111, and the watch strap head grain 122 is connected to the casing 110 by using the first groove 111. Specifically, when the watch strap assembly 120 is connected to the casing 110, the first groove 111 and the second groove 1211 are spliced to jointly form a second receiving cavity 130. In addition, the watch strap head grain 122 is located in the second receiving cavity 130. A projection of the second receiving cavity 130 in a thickness direction of the wearable electronic device 100 at least partially overlaps with a projection of the first receiving cavity 112 in the thickness direction of the wearable electronic device 100.

In this way, a projection of the watch strap head grain 122 in the thickness direction of the wearable electronic device 100 overlaps with a projection of the at least the part of the radiating element 141 of the antenna assembly 140 in the thickness direction of the wearable electronic device 100. In other words, locations of the watch strap head grain 122 and the radiating element 141 of the antenna assembly 140 do not interfere with each other in a wearing span direction L1 of the wearable electronic device 100, and occupy a small space. Therefore, a stacking design of the antenna assembly 140, the casing 110, and the watch strap head grain 122 can ensure the antenna clearance and satisfy an antenna indicator. In this way, a size of the wearable electronic device 100 in the wearing span direction L1 is minimized, so that an overall length of the wearable electronic device 100 is small. This can improve wearing experience of the user to some extent.

In this embodiment of this application, a shape of the watch strap head grain 122 may be a square, a circle, an irregular shape, or any other combination shape. This is not limited in embodiments of this application. Similarly, shapes of the first groove 111 and the second groove 1211 adapt to the shape of the watch strap head grain 122. For example, the shapes of the first groove 111 and the second groove 1211 may be squares, circles, irregular shapes, or any other combination shapes. This is not limited in embodiments of this application.

For example, in the wearable electronic device 100 shown in FIG. 2B or FIG. 4, a sufficient antenna clearance can be ensured, and a wearing span size of the wearable electronic device 100 can be reduced by more than 4 mm.

It is easy to understand that the wearing span size of the wearable electronic device 100 is a distance between outer edges of two watch strap head grains 122 at two ends of the wearable electronic device 100 along the wearing span direction L1.

An example in which the wearable electronic device 100 is a watch is used. In this embodiment of this application, the antenna assembly 140 may be disposed on at least one side of two sides of the watch strap assembly 120. For example, the antenna assembly 140 may be disposed on the watch in a twelve o'clock direction or a six o'clock direction along the wearing span direction L1. This is not limited in embodiments of this application.

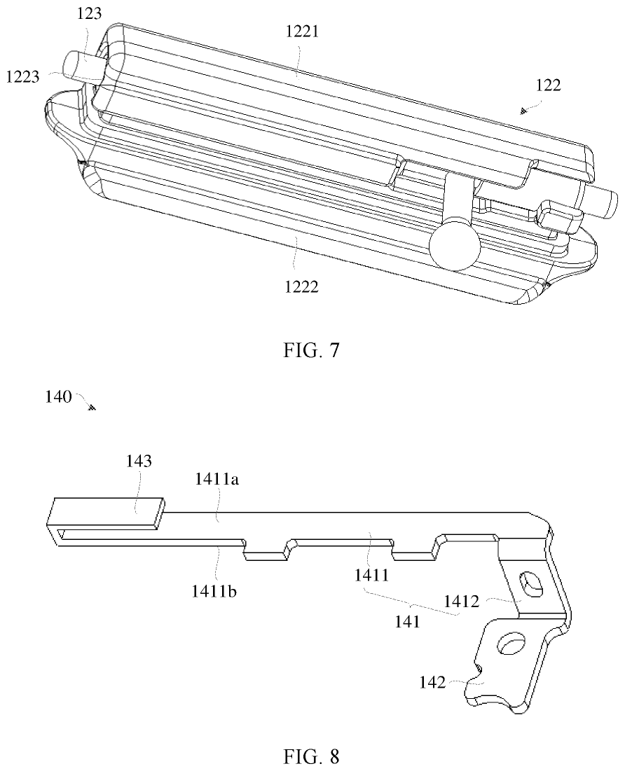

With reference to FIG. 2B or FIG. 4, in this embodiment of this application, the watch strap assembly 120 may further include a spring bar 123, and the spring bar 123 is located in the first groove 111. Specifically, a through hole 1223 (as shown in FIG. 7) extending in a width direction of the casing 110 may be provided in the watch strap head grain 122, and the spring bar 123 may run through the through hole 1223 to connect the casing 110 and the watch strap assembly 120. In other words, the spring bar 123 fits with the watch strap head grain 122, and can connect the casing 110 and the watch strap assembly 120.

In addition, with reference to FIG. 7, the watch strap head grain 122 may include a first part 1221 and a second part 1222. The first part 1221 is fastened to the second part 1222. The first part 1221 may be located in the first groove 111 of the casing 110, and a shape of the first part 1221 adapts to a shape of the first groove 111. The second part 1222 may be located in the second groove 1211 of the watch strap 121, and a shape of the second part 1222 adapts to a shape of the second groove 1211.

It should be noted that an example in which the wearable electronic device 100 is a watch is used. The spring bar 123 is a connecting piece for fastening the watch strap 121 and the watch face (namely, the casing 110). For example, the spring bar 123 may be a steel rod.

In a possible implementation, a spring bar hole 131 may be provided at a location that is on a side wall of the first groove 111 and that is opposite to the through hole 1223. Two ends of the spring bar 123 are located in the spring bar hole 131.

In this embodiment of this application, the watch strap head grain 122 may be formed by using plastic, stainless steel, or another functional material. The spring bar 123 may include but is not limited to a single flange spring bar or a double flange spring bar. If a detaching function is not considered, the spring bar 123 may be a common spring bar.

It may be understood that the watch strap assembly 120 may not include the watch strap head grain 122. For example, in some embodiments, the watch strap assembly 120 may include a watch strap 121 and a spring bar 123. The watch strap 121 may be directly connected to the casing 110 by using the spring bar 123. For example, a through hole (not shown in the figure) that can be passed through by the spring bar 123 may be provided at an end that is of the watch strap 121 and that faces the casing 110. The spring bar 123 runs through the through hole, and two ends of the spring bar 123 are located in the spring bar hole 131 on the first groove 111, to implement connection between the watch strap 121 and the casing 110.

Alternatively, in some embodiments, the watch strap assembly 120 may further include more other components. A structure and composition of the watch strap assembly 120 are not limited in embodiments of this application.

In some embodiments, an orthographic projection of the first receiving cavity 112 in a thickness direction of the casing 110 may be located in the second receiving cavity 130. In this way, a space occupied by the first receiving cavity 112 and the second receiving cavity 130 in the wearing span direction L1 of the wearable electronic device 100 equals to a space occupied by the second receiving cavity 130 in the wearing span direction L1 of the wearable electronic device 100. Extra spaces in the wearing span direction L1 of the wearable electronic device 100 are not occupied, so that a size of the wearable electronic device 100 in the wearing span direction L1 can be greatly reduced.

In descriptions of embodiments of this application, it should be noted that, unless otherwise clearly specified and limited, the terms “installation”, “connection to”, and “connection” should be understood in a broad sense. For example, the connection may be fastening, may be an indirect connection by using an intermediate medium, or may be an internal connection between two elements or an interaction relationship between two elements. Persons of ordinary skill in the art may understand specific meanings of the foregoing terms in embodiments of this application based on a specific situation.

In embodiments of this application, it is implied that an apparatus or element in question needs to have a particular orientation, or needs to be constructed and operated in a particular orientation, and therefore cannot be construed as a limitation on embodiments of this application. In the descriptions of embodiments of this application, unless otherwise exactly and specifically ruled, “a plurality of” means two or more than two.

In the specification, claims, and accompanying drawings of embodiments of this application, the terms “first”, “second”, “third”, “fourth”, and the like (if existent) are intended to distinguish between similar objects but do not necessarily indicate a specific order or sequence. It should be understood that data used in such a way is interchangeable in proper circumstances, so that embodiments of this application described herein can be implemented in other sequences than the sequence illustrated or described herein. In addition, the terms “may include”, “have”, and any variants thereof are intended to cover a non-exclusive inclusion. For example, a process, method, system, product, or device that includes a series of steps or units is not necessarily limited to those clearly listed steps or units, but may include other steps or units that are not clearly listed or are inherent to the process, method, product, or device.

Finally, it should be noted that the foregoing embodiments are merely used to describe the technical solutions of embodiments of this application, but not to limit embodiments of this application. Although embodiments of this application are described in detail with reference to the foregoing embodiments, persons of ordinary skill in the art should understand that they may still make modifications to the technical solutions recorded in the foregoing embodiments or make equivalent replacements to some or all technical features thereof. Such modifications or replacements do not make the essence of the corresponding technical solutions depart from the scope of the technical solutions of embodiments of this application.

What is claimed is:

1. An electronic device, comprising at least:
a casing and an antenna assembly, wherein
at least one outer side wall of the casing is provided with a first groove that is configured to connect at least the electronic device and an external component, a first receiving cavity is further provided inside the casing, at least a part of a radiating element of the antenna assembly is located in the first receiving cavity, and a projection of the first receiving cavity in a thickness direction of the electronic device at least partially overlaps with a projection of the first groove in the thickness direction of the electronic device.

2. The electronic device according to claim 1, wherein the first receiving cavity is located in a space enclosed by a middle frame of the electronic device, a top wall of the first groove, an outer side wall that is of the casing and that is away from the middle frame, and a plane on which a display of the electronic device is located.

3. The electronic device according to claim 1, wherein the antenna assembly comprises at least the radiating element and a feeding unit connected to the radiating element; and
the feeding unit is further connected to a circuit board of the electronic device.

4. The electronic device according to claim 3, wherein the antenna assembly further comprises a radiating branch; and one end of the radiating element is connected to one end of the radiating branch, and the other end of the radiating element is connected to the feeding unit; and
the other end of the radiating branch bends in a direction away from a surface of the radiating element, and extends toward an extension direction of the radiating element.

5. The electronic device according to claim 4, wherein the radiating element comprises a main body portion and a bending support portion; and
one end of the main body portion is connected to the radiating branch, the other end of the main body portion is connected to one end of the bending support portion, and the other end of the bending support portion is connected to the feeding unit.

6. The electronic device according to claim 5, wherein the radiating element has a first side face and a second side face opposite to the first side face;
one end of the radiating branch is connected to one end of the main body portion of the radiating element, and the other end of the radiating branch bends in a direction away from the second side face and extends toward the other end of the main body portion; and
one end of the feeding unit is connected to one end of the bending support portion of the radiating element, and the other end of the feeding unit extends in a direction perpendicular to a plane on which the bending support portion is located.

7. The electronic device according to claim 5, wherein the radiating element has a first side face and a second side face opposite to the first side face;
one end of the radiating branch is connected to one end of the main body portion of the radiating element, and the other end of the radiating branch bends in a direction away from the first side face and extends toward the other end of the main body portion; and
one end of the feeding unit is connected to one end of the bending support portion of the radiating element, and the other end of the feeding unit extends in a direction perpendicular to a plane on which the bending support portion is located.

8. The electronic device according to claim 3, wherein the antenna assembly further comprises a grounding unit; and one end of the radiating element is connected to the grounding unit, and the other end of the radiating element is connected to the feeding unit; and
the grounding unit and the feeding unit are disposed opposite to each other.

9. The electronic device according to claim 8, wherein the radiating element is provided with a coupling gap; and
the coupling gap is disposed in a staggered manner relative to the grounding unit and the feeding unit.

10. The electronic device according to claim 8, wherein the radiating element comprises a main body portion and a bending support portion; and
one end of the main body portion is connected to the grounding unit, the other end of the main body portion is connected to one end of the bending support portion, and the other end of the bending support portion is connected to the feeding unit; or
one end of the main body portion is connected to the feeding unit, the other end of the main body portion is connected to one end of the bending support portion, and the other end of the bending support portion is connected to the grounding unit.

11. The electronic device according to claim 3, further comprising a battery, wherein the battery is located inside the casing; and
an accommodating cavity is formed between an outer side wall of the battery and an inner side wall of the casing, the accommodating cavity is configured to accommodate at least the feeding unit, and the accommodating cavity communicates with the first receiving cavity to jointly accommodate the antenna assembly.

12. The electronic device according to claim 11, wherein a distance between the battery and the radiating element is greater than 1 mm.

13. An electronic device assembly, comprising at least a watch strap assembly and an electronic device, wherein the electronic device comprising at least: a casing and an antenna assembly, wherein
at least one outer side wall of the casing is provided with a first groove that is configured to connect at least the electronic device and an external component, a first receiving cavity is further provided inside the casing, at least a part of a radiating element of the antenna assembly is located in the first receiving cavity, and a projection of the first receiving cavity in a thickness direction of the electronic device at least partially overlaps with a projection of the first groove in the thickness direction of the electronic device;
wherein the watch strap assembly is connected to the electronic device by using the first groove.

14. The electronic device assembly according to claim 13, wherein the watch strap assembly comprises a watch strap and a spring bar connected to the watch strap; and
the first groove is located at one end that is of the casing and that faces the watch strap, and the spring bar is located in the first groove to connect the casing and the watch strap assembly.

15. The electronic device assembly according to claim 14, wherein a spring bar hole is provided on a side wall of the first groove; and
two ends of the spring bar are located in the spring bar hole.

16. The electronic device assembly according to claim 14, wherein the watch strap assembly further comprises a watch strap head grain, and the watch strap head grain is connected to the watch strap; and
at least a part of the watch strap head grain is located in the first groove, a through hole extending in a width direction of the casing is provided in the watch strap head grain, and the spring bar runs through the through hole to connect the casing and the watch strap assembly, wherein
the spring bar hole and the through hole are disposed opposite to each other.

17. The electronic device assembly according to claim 13, wherein the first receiving cavity is located in a space enclosed by a middle frame of the electronic device, a top wall of the first groove, an outer side wall that is of the casing and that is away from the middle frame, and a plane on which a display of the electronic device is located.

18. The electronic device assembly according to claim 13, wherein the antenna assembly comprises at least the radiating element and a feeding unit connected to the radiating element; and
the feeding unit is further connected to a circuit board of the electronic device.

19. The electronic device assembly according to claim 18, wherein the antenna assembly further comprises a radiating branch or a grounding unit;
wherein one end of the radiating element is connected to one end of the radiating branch, and the other end of the radiating element is connected to the feeding unit; and
the other end of the radiating branch bends in a direction away from a surface of the radiating element, and extends toward an extension direction of the radiating element;
wherein one end of the radiating element is connected to the grounding unit, and the other end of the radiating element is connected to the feeding unit; and
the grounding unit and the feeding unit are disposed opposite to each other.

20. The electronic device assembly according to claim 18, further comprising a battery, wherein the battery is located inside the casing; and
an accommodating cavity is formed between an outer side wall of the battery and an inner side wall of the casing, the accommodating cavity is configured to accommodate at least the feeding unit, and the accommodating cavity communicates with the first receiving cavity to jointly accommodate the antenna assembly.
